(19) United States
(12) Patent Application Publication
(10) Pub. No.: US 2009/0146989 A1
(43) Pub. Date: Jun. 11, 2009

(54) Chromaticity converting device, timing controller, liquid crystal display apparatus, and chromaticity converting method

(76) Inventor: Kazuma Hirao, Osaka (JP)

Correspondence Address: HARNESS, DICKEY & PIERCE, P.L.C., P.O. BOX 8910, RESTON, VA, 20195, US

(21) Appl. No.: 11/990,910

(22) PCT Filed: Jun. 30, 2006
(86) PCT No.: PCT/JP2006/313141

§ 371 Date: Feb. 25, 2008

(30) Foreign Application Priority Data
Sep. 30, 2005 (JP) 2005289426

(51) Int. Cl. G09G 5/00; G09G 3/18

(52) U.S. Cl. 345/214; 345/50

(57) ABSTRACT

In one embodiment of the present invention, a chromaticity converting device is realized which can appropriately correct a shift in hue caused by a leakage of green light from a blue color filter when a color filter having improved transmittance is used to increase luminance. The chromaticity converting device serves to perform chromaticity conversion with respect to an RGB signal, converts a gradation of G data so that the gradation of the G data decreases in a predetermined region A1 around B within a range of chromaticities expressible by the RGB signal, and converts the gradation of G data so that the gradation of G data increases in a predetermined region A2 around Y, which is a complementary color of B, within the range of chromaticities.

### TECHNICAL FIELD

The present invention relates to chromaticity conversion with respect to a three-primary-color signal including first to third color data indicating gradations of first to third colors, respectively.

### BACKGROUND ART

In recent years, liquid crystal display apparatuses have been widely used for displays in television screens as well as for monitors in personal computers and the like. Accordingly, the liquid crystal display apparatuses have been frequently compared with CRT (cathode-ray tube) display apparatuses in terms of image quality, luminance, and color reproducibility. Further, since the liquid crystal display apparatuses have been mounted on laptop personal computers that allow viewing of television screens and screens displayed by playing back DVDs (digital versatile disks), the liquid crystal display apparatuses have been required to be lighter in weight and higher in luminance.

Generally speaking, in order to carry out a high-luminance display with use of a non-emissive color display apparatus typified by a liquid crystal display apparatus, it is effective to brighten a backlight (increase the number of cold-cathode tubes). However, due to weight and thickness constraints, it is difficult for a lightweight and low-profile liquid crystal display apparatus for use in a laptop personal computer or the like to brighten a backlight by increasing the number of cold-cathode tubes. In order to improve luminance without brightening a backlight, such measures are taken as to lighten the color of a color filter, i.e., to increase the transmittance of a color filter.

However, the thinning of a color filter causes deterioration in color reproducibility. Therefore, whereas a display apparatus for exclusive use in a television generally has a chromaticity range (color reproduction range, chromaticity gamut) in conformity with EBU (European Broadcasting Union) (corresponding to an NTSC (National Television Standards Committee) ratio of 72%) regardless of the type of display apparatus such as CRT display or liquid crystal display, a liquid crystal display apparatus for use in a laptop personal computer generally has a chromaticity range in conformity with an NTSC ratio of 50% or less as a result of the thinning of a color filter.

FIG. 14 is a graph showing the RGB transmittances of an EBU-compatible color filter and the spectral radiance of a cold-cathode tube, the transmittances and the spectral radiance being superimposed on one another. The spectral radiance of a cold-cathode tube has peaks at wavelengths corresponding to blue, green, and red, respectively.

For example, in a liquid crystal display apparatus obtained by combining the color filter with the cold-cathode tube, when those liquid crystals which are layered on a blue color filter are turned ON (transmission), the blue color filter transmits only a substantially blue peak wavelength because of its transmittance characteristic. The blue color filter does not transmit the remaining green and red peak wavelengths. Therefore, blue is displayed.

Similarly, when those liquid crystals which are layered on a green color filter are turned ON (transmission), only the green peak wavelength is transmitted, so that green is displayed. When those liquid crystals which are layered on the red color filter are turned ON (transmission), only the red peak wavelength is transmitted, so that red is displayed.

Moreover, when those liquid crystals which are layered on the respective RGB color filters are controlled, for example, so as to have 64 gradations or 256 gradation, a full-color display having approximately 260,000 colors or approximately 16,770,000 colors is realized.

FIG. 15 is a graph showing the RGB transmittances of a color filter having an NTSC ratio of approximately 45% and the spectral radiance of a cold-cathode tube, the transmittances and the spectral radiance being superimposed on one another. The color filter has colors lightened so that the transmission ranges of wavelengths respectively corresponding to RGB are widened. This realizes high luminance by increasing the transmittances of the color filter.

However, the widening of a range of wavelengths that are transmitted by a color filter causes such a problem that the color filter transmits an adjacent color that is not supposed to be transmitted. As shown in FIG. 15, the transmittance of a blue color filter is relatively high at the green peak wavelength of the spectral radiance of the cold-cathode tube (see the portion encircled by the dotted line in FIG. 5). This means that the blue color filter is transmitting green light, i.e., that the blue color filter is not blocking green light.

FIG. 16 is a chromaticity diagram obtained by showing, on an x-y chromaticity coordinate called a CIE (Commission Internationale de l'Eclairage) 1931 chromaticity diagram, the chromaticity ranges of liquid crystal display apparatuses using the color filters of FIGS. 14 and 15, respectively.

FIG. 16 shows the chromaticity range of the color filter having an NTSC ratio of 45% (represented by the solid line in FIG. 16) has a smaller area than the chromaticity range of the EBU-compatible color filter (represented by the dotted line in FIG. 16). In addition, FIG. 16 also shows a shift in blue coordinates. That is, the chromaticity range of the color filter having an NTSC ratio of 45% has blue coordinates B′ obviously shifted toward green (G) as compared with the blue coordinates B of the chromaticity range of the EBU-compatible color filter.

The blue coordinates B and the blue coordinates B′ forms an angle of θ with each other as seen from white (W). This angle means a difference in hue. An attempt to display blue with use of the color filter having an NTSC ratio of 45% results in a display of blue green obtained by shifting blue toward green by an angle of θ.

Further, when those liquid crystals which are layered on a blue color filter are turned OFF (light shielding) and those liquid crystals which are respectively layered on green and red color filters are turned ON (transmission), yellow, which is a complementary color of blue, is supposed to be displayed due to a color mixture of green and red. However, the blue color filer also transmits green. Therefore, when the blue peak wavelength is reduced by turning OFF those liquid crystals which are layered on the blue color filter, the green peak wavelength is also reduced. As a result, the actually displayed yellow is short of green and its hue shifts toward red, so that the actually displayed yellow appears to be orange.

This will be described below with reference to FIG. 16. In the chromaticity range of the EBU-compatible color filter, the coordinates on chromaticity diagram of yellow that is displayed due to a color mixture of green and red are indicated by the yellow coordinates Y located on a line connecting G with R and on a line connecting B with W. However, in the chromaticity range of the color filter having an NTSC ratio of 45%, since the blue coordinates B have shifted toward G so as to be on the blue coordinates B′, the yellow coordinates Y shift toward R so as to be on the yellow coordinates Y′. Therefore, an attempt to display yellow with use of the color filter having an NTSC ratio of 45% results in a display of orange obtained by shifting yellow toward red.

The generation of such a shift in hue is not limited to the time when the color of a color filter is lightened. Another example of a shift in hue will be described below with reference to FIG. 17.

FIG. 17 is a graph showing the RGB transmittances of the EBU-compatible color filter of FIG. 14 and the spectral radiances of RGB monochromatic LED (light-emitting diode) backlights, the transmittances and the spectral radiances being superimposed on one another. Generally speaking, the peak wavelengths of the blue and green monochromatic LED backlights tend to be shorter than the peak wavelength of a cold-cathode tube, and the peak wavelength of the red monochromatic LED backlight tends to be longer than the peak wavelength of a cold-cathode tube.

That is, since the peak wavelength of the green monochromatic LED backlight shifts toward a shorter wavelength (blue), the transmittance of a blue color filter is relatively high even at the peak wavelength of the green monochromatic LED backlight (see the portion encircled by the dotted line in FIG. 15). This means that the blue color filter is transmitting green light, i.e., that the blue color filter is not blocking green light. As a result, as with the case where the color of a color filter is lightened, blue shifts toward green and yellow shifts toward red.

Thus, in cases where a color display is carried out by mixing three primary colors of light such as RGB, a shift in hue may be caused by any one of the three primary colors of light shifting toward another primary color having a wavelength adjacent to the wavelength of the primary color.

In order to correct such a shift in hue, it is necessary to perform hue conversion.

It should be noted here that examples of publicly known documents that disclose techniques for hue conversion include Patent Documents 1 and 2.

The technique disclosed in Patent Document 1 has as an object to provide novel hue conversion different from conventional hue conversion by which a hue is converted by changing only a color-difference signal. In cases where the direction in which a hue is converted and the amount by which the hue is changed are predetermined, an input signal is converted by performing a predetermined computation with use of the signal, the predetermined direction in which the hue is converted, and the predetermined amount by which the hue is changed.

Further, the technique disclosed in Patent Document 2 relates to a conversion technique for improving the computing speed and retaining smoothness in gradation in color conversion using color conversion coefficients serving as adjustment amounts corresponding to hue, saturation, and brightness by which a target color gamut is obtained, or adjustment amounts corresponding to hue, saturation, and brightness according to a user's preference.

### [Patent Document 1]

Japanese Unexamined Patent Application Publication No. 111091/2003 (Tokukai 2003-111091; published on Apr. 11, 2003) (see paragraphs [0002], [0003], and [0020] through [0025])

[Patent Document 2]

Japanese Unexamined Patent Application Publication No. 244458/2003 (Tokukai 2003-244458; published on Aug. 29, 2003) (see paragraphs [0007], [0022], and [0023])

### DISCLOSURE OF THE INVENTION

### Problems to be Solved by the Invention

However, neither of the techniques disclosed in Patent Documents 1 and 2 considers a shift in hue that is caused when a specific color (e.g., blue or yellow) is displayed. Therefore, the techniques disclosed in Patent Documents 1 and 2 have a difficulty in appropriately eliminating such a shift in hue as described above.

Specifically, although the technique disclosed in Patent Document 1 presupposes that the direction in which the hue is converted and the amount by which the hue is changed are predetermined, Patent Document 1 discloses no such direction or amount as to eliminate the shift in hue. Further, although the technique disclosed in Patent Document 2 presupposes the color conversion using the adjustment amounts corresponding to hue, saturation, and brightness, Patent Document 2 discloses no such adjustment amounts as to eliminate the shift in hue.

The present invention has been made in view of the foregoing problems, and it is an object of the present invention to realize chromaticity conversion by which a shift in hue can be appropriately corrected.

### Means to Solve the Problems

A chromaticity converting device according to the present invention is a chromaticity converting device for performing chromaticity conversion with respect to a three-primary color signal including first to third color data indicating gradations of first to third colors, respectively, the gradation of the second color data being converted so as to decrease in a predetermined region around the first color within a range of chromaticities expressible by the three-primary-color signal, the gradation of the second color data being converted so as to increase in a predetermined region around a complementary color of the first color within the range of chromaticities.

Further, a chromaticity converting method according to the present invention is a chromaticity converting method for performing chromaticity conversion with respect to a three-primary color signal including first to third color data indicating gradations of first to third colors, respectively, the gradation of the second color data being converted so as to decrease in a predetermined region around the first color within a range of chromaticities expressible by the three-primary-color signal, the gradation of the second color data being converted so as to increase in a predetermined region around a complementary color of the first color within the range of chromaticities.

As described in BACKGROUND ART, in a display apparatus that displays an image in accordance with a three-primary-color signal such as an RGB signal, when a first color (e.g., blue) of three primary colors corresponding to the three-primary-color signal is displayed, light having a second color (e.g., green) may leak due to the characteristics of a color filter used in the display apparatus.

The first to third colors are related to one another such that their respective wavelengths are arranged in the same order as the first to third colors. (The first color may have a shorter wavelength than the second color, and the second color may have a shorter wavelength than the third color. Alternatively, the first color may have a longer wavelength than the second color, and the second color may have a longer wavelength than the third color.) That is, the first to third colors are related to one another such that the wavelength of the second color lies between the wavelength of the first color and the wavelength of the third color.

Such a display apparatus carries out a display such that, with respect to the original hue supposed to be displayed in accordance with the three-primary-color signal, a hue close to the first color shifts toward the second color and a hue close to the complementary color of the first color shift toward the third color.

In view of this, the arrangement and method converts the gradation of the second color data so that the gradation of the second color data increases in the predetermined region around the first color within the range of chromaticities expressible by the three-primary-color signal, and converts the gradation of the second color data so that the gradation of the second color data decreases in the predetermined region around the complementary color of the first color within the range of chromaticities.

The “predetermined region around the first color” here means a region that is closer to the first color than a predetermined boundary one end of which is located on a line connecting the first color to the second color (excluding the chromaticity coordinates of the first color) and the other end of which is located on a line connecting the first color with the third color (excluding the chromaticity coordinates of the first color). Similarly, the “predetermined region around the complementary color of the first color” here means a region that is closer to the complementary color of the first color than a predetermined boundary one end of which is located on a line connecting the complementary color of the first color with the second color (excluding the chromaticity coordinates of the complementary color of the first color) and the other end of which is located on a line connecting the complementary color of the first color with the third color (excluding the chromaticity coordinates of the complementary color of the first color). Note that the “predetermined region around the first color” and the “predetermined region around the complementary color of the first color” are set so as not to overlap each other.

With this, the shift in hue close to the first color can be corrected by converting the gradation of the second color data so that the gradation of the second color data decreases in the predetermined region around the first color, and the shift in hue close to the complementary color of the first color can be corrected by converting the gradation of the second color data so that the gradation of the second color data increases in the predetermined region around the complementary color of the first color.

The amount by which the gradation is converted can be appropriately set by understanding to what degree the chromaticity coordinates of each primary color in the range of chromaticities of a display apparatus used shift in hue from the chromaticity coordinates of each primary color in the range of chromaticities (e.g., EBU standards or NTSC standards) assumed by a three-primary-color signal. With this, the amount by which the gradation is converted can be appropriately set in such a manner that a shift in hue of a display that is caused by the shift in hue of coordinates is reduced.

This makes it possible to realize such chromaticity conversion as to be able to appropriately correct the aforementioned shift in hue.

The three-primary-color signal is not limited to an RGB signal, and may be a signal, obtained by combining other colors, such as a CMY signal (C: cyan, M: magenta, Y: yellow).

Further, the foregoing problems can happen not only in such a case where blue is displayed as described in BACKGROUND ART, but also in cases where other colors are displayed. It is obvious that the arrangement and method can be applied also in such cases.

The chromaticity converting device according to the present invention may be arranged such that the gradations of the first to third color data are not converted in a region other than the predetermined region around the first color and the predetermined region around the complementary color of the first color within the range of chromaticities.

According to the foregoing arrangement, the gradations of the first to third color data are not converted in a region other than the predetermined region around the first color and the predetermined region around the complementary color of the first color within the range of chromaticities. This makes it possible to avoid making an unnecessary correction in a region where there is hardly such a shift in hue as described above.

The chromaticity converting device according to the present invention may be arranged such that the gradation of the second color data is converted so that: as a chromaticity expressed by the three-primary-color signal becomes closer to the first color, an amount by which the gradation of the second color data decreases in the predetermined region around the first color becomes larger; and as the chromaticity expressed by the three-primary-color signal becomes closer to the complementary color of the first color, an amount by which the gradation of the second color data increases in the predetermined region around the complementary color of the first color becomes larger.

The aforementioned shift in chromaticity due to a shift in hue of a display apparatus becomes larger as a chromaticity expressed by the three-primary-color signal becomes closer to the first color and as a chromaticity expressed by the three-primary-color signal becomes closer to the complementary color of the first color.

In view of this, according to the foregoing arrangement, the gradation of the second color data is converted so that the amount (amount of correction) by which the gradation of the second color data decreases or increases becomes larger as a chromaticity expressed by the three-primary-color signal becomes closer to the first color and as a chromaticity expressed by the three-primary-color signal becomes closer to the complementary color of the first color. This makes it possible to make an appropriate correction in accordance with the degree of the aforementioned shift in a display apparatus.

Note that the chromaticity converting device according to the present invention can be arranged such that: the predetermined region around the first color is a region, surrounded by the first color, a complementary color of the second color, a complementary color of the third color, and an achromatic color, which falls within the range of chromaticities; and the predetermined region around the complementary color of the first color is a region surrounded by the second color, the third color, and the achromatic color.

The chromaticity converting device according to the present invention may be arranged such that: when the gradation of the second color data is below a lower limit value, the gradation of the third color data is converted so as to increase; and when the gradation of the second color data is above an upper limit value, the gradation of the third color data is converted so as to decrease.

According to the foregoing arrangement, in cases where the conversion has caused the gradation of the second color data to be below the lower limit value or to be above the upper limit value, the gradation of the third color data is increased or decreased, respectively. This makes it possible to avoid blurring a gradation that is to be displayed.

Further, the chromaticity converting device according to the present invention may be arranged such that: the predetermined region around the first color is a region, surrounded by the first color, the second color, the third color, and an achromatic color, which falls within the range of chromaticities; and the predetermined region around the complementary color of the first color is a region surrounded by the second color, the third color, and the achromatic color.

The chromaticity converting device according to the present invention may be arranged such that: when the gradation of the second color data is below a lower limit value, the gradation of the third color data is converted so as to increase; and when the gradation of the second color data is above an upper limit value, the gradation of the third color data is converted so as to decrease.

According to the foregoing arrangement, in cases where the conversion has caused the gradation of the second color data to be below the lower limit value or to be above the upper limit value, the gradation of the third color data is increased or decreased, respectively. This makes it possible to avoid blurring a gradation that is to be displayed.

The chromaticity converting device according to the present invention may be arranged such that: when the gradation of the third color data is below a lower limit value, the gradation of the first color data is converted so as to increase; and when the gradation of the third color data is above an upper limit value, the gradation of the first color data is converted so as to decrease.

According to the foregoing arrangement, in cases where the conversion has caused the gradation of the third color data to be below the lower limit value or to be above the upper limit value, the gradation of the first color data is increased or decreased, respectively. This makes it possible to avoid blurring a gradation that is to be displayed.

Note that the first to third colors are blue, green, and red, respectively.

A timing controller according to the present invention is a timing controller for controlling timing of a signal in an image display apparatus, including a chromaticity converting device as set forth in any one of the aforementioned arrangements.

Further, a liquid crystal display apparatus according to the present invention includes: a chromaticity converting device as set forth in any one of the aforementioned arrangements; and a liquid crystal panel having color filters respectively corresponding to first to third colors.

Because of the functions of the aforementioned chromaticity converting device, each of the foregoing arrangements makes it possible to realize a timing controller or liquid crystal display apparatus that can appropriately correct the aforementioned shift in hue. It should be noted that a chromaticity converting device can be realized easily and inexpensively by mounting a chromaticity converting device in a timing controller originally for processing data and generating a timing signal.

### EFFECTS OF THE INVENTION

The chromaticity converting device according to the present invention is arranged such that: the gradation of the second color data is converted so as to decrease in a predetermined region around the first color within a range of chromaticities expressible by the three-primary-color signal; and the gradation of the second color data is converted so as to increase in a predetermined region around a complementary color of the first color within the range of chromaticities.

The chromaticity converting method according to the present invention is arranged such that: the gradation of the second color data is converted so as to decrease in a predetermined region around the first color within a range of chromaticities expressible by the three-primary-color signal; and the gradation of the second color data is converted so as to increase in a predetermined region around a complementary color of the first color within the range of chromaticities.

The arrangement and method converts the gradation of the second color data so that the gradation of the second color data increases in the predetermined region around the first color within the range of chromaticities expressible by the three-primary-color signal, and converts the gradation of the second color data so that the gradation of the second color data decreases in the predetermined region around the complementary color of the first color within the range of chromaticities.

Thus, the shift in hue close to the first color can be corrected by converting the gradation of the second color data so that the gradation of the second color data decreases in the predetermined region around the first color, and the shift in hue close to the complementary color of the first color can be corrected by converting the gradation of the second color data so that the gradation of the second color data increases in the predetermined region around the complementary color of the first color.

This makes it possible to realize such chromaticity conversion as to be able to correct such a shift in hue as described in BACKGROUND ART.

### BRIEF DESCRIPTION OF DRAWINGS

FIG. 1 is a block diagram showing an arrangement of a liquid crystal display apparatus according to Embodiments 1 and 2 of the present invention.

FIG. 2 is a block diagram showing an arrangement of a chromaticity converting device according to Embodiment 1 of the present invention.

FIG. 3 is a chromaticity diagram for explaining chromaticity conversion according to Embodiment 1 of the present invention.

FIG. 4 is a flow chart showing the flow of a chromaticity converting process according to Embodiment 1 of the present invention.

FIGS. 5(a) and 5(b) are tables showing specific examples of changes in gradation by the chromaticity conversion according to Embodiment 1 of the present invention.

FIG. 6 is a chromaticity diagram showing a trend of shift in chromaticity by the chromaticity conversion according to Embodiment 1 of the present invention.

FIG. 7 is a chromaticity diagram showing a trend of shift in chromaticity by chromaticity conversion serving as a comparative example.

FIG. 8 is a block diagram showing an arrangement of a chromaticity converting device according to Embodiment 2 of the present invention.

FIG. 9 is a flow chart showing the flow of a chromaticity converting process according to Embodiment 2 of the present invention.

FIGS. 10(a) and 10(b) are tables showing specific examples of changes in gradation by the chromaticity conversion according to Embodiment 2 of the present invention.

FIG. 11 is a chromaticity diagram showing a trend of shift in chromaticity by the chromaticity conversion according to Embodiment 2 of the present invention.

FIG. 12 is a chromaticity diagram for explaining a destination into which blue data is converted by the chromaticity conversion according to Embodiments 1 and 2 of the present invention.

FIG. 13 is a chromaticity diagram for explaining a destination into which yellow data is converted by the chromaticity conversion according to Embodiments 1 and 2 of the present invention.

FIG. 14 is a graph showing the transmittances of an ordinary color filter and the spectral radiance of a cold-cathode tube, the transmittances and the spectral radiance being superimposed on one another.

FIG. 15 is a graph showing the transmittances of a color filter having improved transmittances and the spectral radiance of a cold-cathode tube, the transmittances and the spectral radiance being superimposed on one another.

FIG. 16 is a chromaticity diagram showing a chromaticity range in conformity with EBU and a chromaticity range in conformity with an NTSC ratio of 45%.

FIG. 17 is a graph showing the transmittances of an ordinary color filter and the spectral radiance of an LED, the transmittances and the spectral radiance being superimposed on one another.

### REFERENCE NUMERALS

11 Liquid crystal display apparatus
12 Display signal generator
18 Timing controller
28 Liquid crystal panel
30 Chromaticity converting device
31 Hue determining unit
32 B component calculating unit
33 G correction amount calculating unit
34 G data computing unit
35 Excess determining unit
36 R data computing unit
40 Hue converting device
41 RG determining unit
42 B determining unit
43 G correction amount calculating unit
44 G data computing unit
45 Excess determining unit
46 R data computing unit
47 Excess determining unit
48 B data computing unit

### BEST MODE FOR CARRYING OUT THE INVENTION

### Embodiment 1

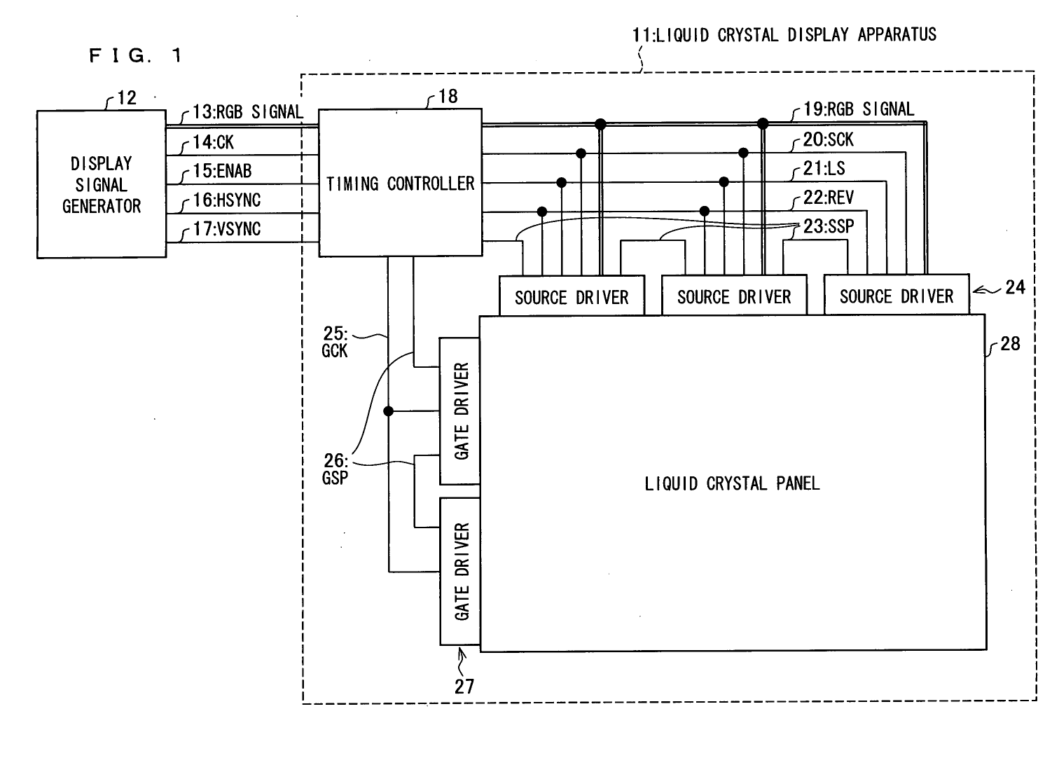

An embodiment of the present invention will be described below with reference to FIGS. 1 through 7. In the following, Embodiment 1 and Embodiment 2 to be described later assume that a liquid crystal display apparatus according to the present invention is a transmissive, normally-white (transmits light when no voltage is applied to the liquid crystals) active-matrix liquid crystal display apparatus (hereinafter referred to as “liquid crystal display apparatus”) having a backlight. This liquid crystal display apparatus includes a color filter, described in BACKGROUND ART, which has a chromaticity range in conformity with an NTSC ratio of 45%. Further, this liquid crystal display apparatus carries out a full-color display by receiving RGB 8-bit (0-255 gradations) image signals.

FIG. 1 is a block diagram showing an arrangement of a liquid crystal display apparatus 11. As shown in FIG. 1, the liquid crystal display apparatus 11 includes a timing controller 18, a source driver 24, a gate driver 27, and a liquid crystal panel 28.

The liquid crystal display apparatus 11 receives an RGB signal 13, a CK 14, an ENAB 15, an HSYNC 16, and a VSYNC 17 from an external display signal generator 12. The RGB signal 13 is an 8-bit image signal. The CK 14 is a clock signal. The ENAB 15 means that data are being transferred. The HSYNC 16 is a horizontal synchronization signal. The VSYNC 17 is a vertical synchronization signal. These signals are received by the timing controller 18 provided in the liquid crystal display apparatus 11.

It is assumed that the signals are transmitted from the display signal generator 12 to the timing controller 18 by a method for transmitting the signals at a CMOS (complementary metal-oxide semiconductor) level. However, the signals may be transmitted from the display signal generator 12 to the timing controller 18, for example, by LVDS (low-voltage differential signaling). The content of the signals stays unchanged regardless of change in transmission method. Further, the essence of the present invention is not constituted by a transmission method.

Upon receiving the signals, the timing controller 18 processes the signals internally, thereby generating an RGB signal 19, an SCK 20, an LS 21, an REV 22, an SSP 23, a GCK 25, and a GSP 26. The RGB signal 19 is an 8-bit image signal. The SCK 20 serves as a clock signal for the source driver 24. The LS 21 determines the timing for outputting a signal to the liquid crystal panel 28. The REV 22 determines the polarity to be written in the liquid crystal panel 28. The SSP 23 determines the timing for loading a signal. The GCK 25 serves as a clock signal for the gate driver 27. The GSP 26 determines the beginning of a frame.

Then, the timing controller 18 outputs the RGB signal 19, the SCK 20, the LS 21, the REV 22, and the SSP 23 to the source driver 24, and outputs the GCK 25 and the GSP 26 to the gate driver 27.

The source driver 24 generates, in accordance with the received signals, gradation signals respectively corresponding to pixels of the liquid crystal panel 28, and outputs the gradation signals to signal lines (not shown) of the liquid crystal panel 28. Further, the gate driver 27 generates scanning signals in accordance with the received signals, and outputs the scanning signals to scanning lines (not shown) of the liquid crystal panel 28.

It is assumed that the signals are transmitted from the timing controller 18 to the source driver 24 by a method for transmitting the signals at a CMOS level. However, the signals may be transmitted from the timing controller 18 to the source driver 24, for example, by RSDS (reduced swing differential signaling). The content of the signals stays unchanged regardless of change in transmission method. Further, the essence of the present invention is not constituted by a transmission method.

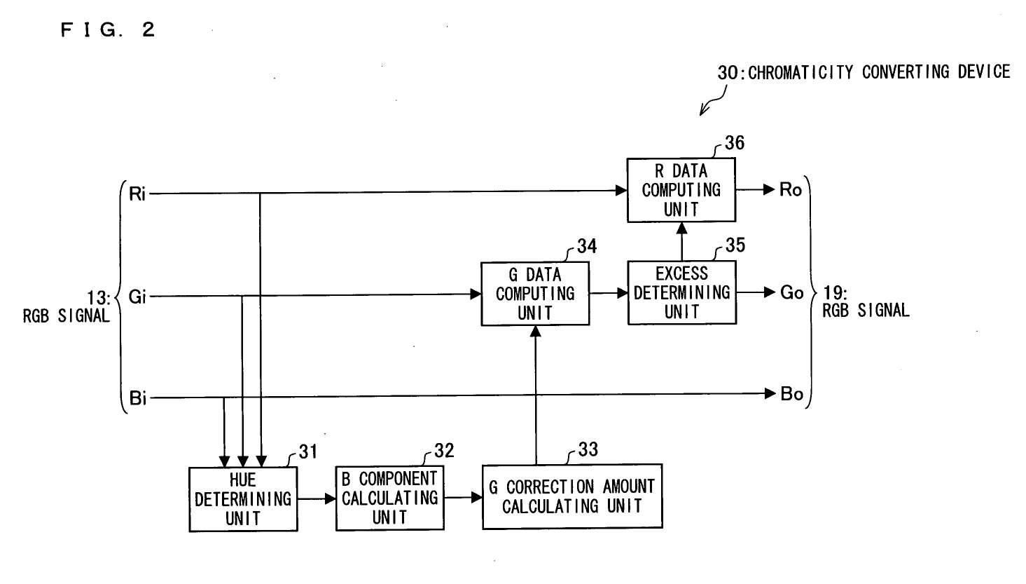

The timing controller 18 contains a chromaticity converting device 30 (see FIG. 2) according to the present invention. It is by the chromaticity converting device 30 that the RGB signal 13, which serves as an input signal, is converted into the RGB signal 19, which serves as an output signal, so as to be compatible with the chromaticity range of the color filter of the liquid crystal panel 28, i.e., with the chromaticity range in conformity with an NTSC ratio of 45%.

The chromaticity converting device does not need to be contained in the timing controller 18. The chromaticity converting device 30 may be contained in the display signal generator 12. Alternatively, the chromaticity converting device 30 may be provided as an independent IC (integrated circuit) outside of those components.

FIG. 2 is a block diagram showing an arrangement of the chromaticity converting device 30 of the present embodiment. As shown in FIG. 2, the chromaticity converting device 30 includes a hue determining unit 31, a B component calculating unit 32, a G correction amount calculating unit 33, a G data computing unit 34, an excess determining unit 35, and an R data computing unit 36.

The RGB signal 13 contains data Ri, Gi, and Bi indicating gradations of RGB, respectively. The RGB signal 19 contains data Ro, Go, and Bo indicating gradations of RGB, respectively.

In the present embodiment, the chromaticity converting device 30 is divided into six functional blocks shown in FIG. 2. However, in designing an actual circuit, these blocks may be appropriately combined or separated. For example, the hue determining unit 31 and the B component calculating unit 32 may be realized by a single circuit.

The following explains the principle of chromaticity conversion in the present embodiment. As described in BACKGROUND ART, a blue color filter of a color filter having an NTSC ratio of 45% transmits part of green light. Therefore, the larger the gradation of the data Bi is, the more of the green light the blue color filter lets out. This makes it conceivable that the gradation of the data Gi is increased or decreased in proportion to the gradation of the data Bi.

However, for example, in case of a white display where all the data Ri, Gi, and Bi have their maximum gradations, a reduction of the gradation of the data Gi for the reason of a leakage of green light due to the large gradation of the data Bi not only causes the displayed white to shift from white, but also causes a decrease in luminance of the displayed colors.

In view of this, as a chromaticity to be displayed becomes closer to blue, the amount of reduction of the gradation of the data Gi is made larger. Further, as the chromaticity to be displayed becomes closer to yellow, which is a complementary color of blue, the amount of increase of the gradation of the data Gi is made larger. With this, the gradation of the data Gi is not corrected for an achromatic color such as white. This causes the amount of correction of the gradation of the data Gi to become larger as the chromaticity to be displayed approaches blue or yellow from the achromatic color, thereby enabling chromaticity conversion suited to the characteristics of the color filter.

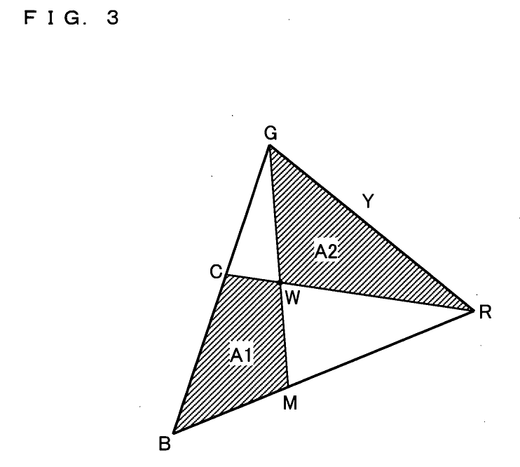

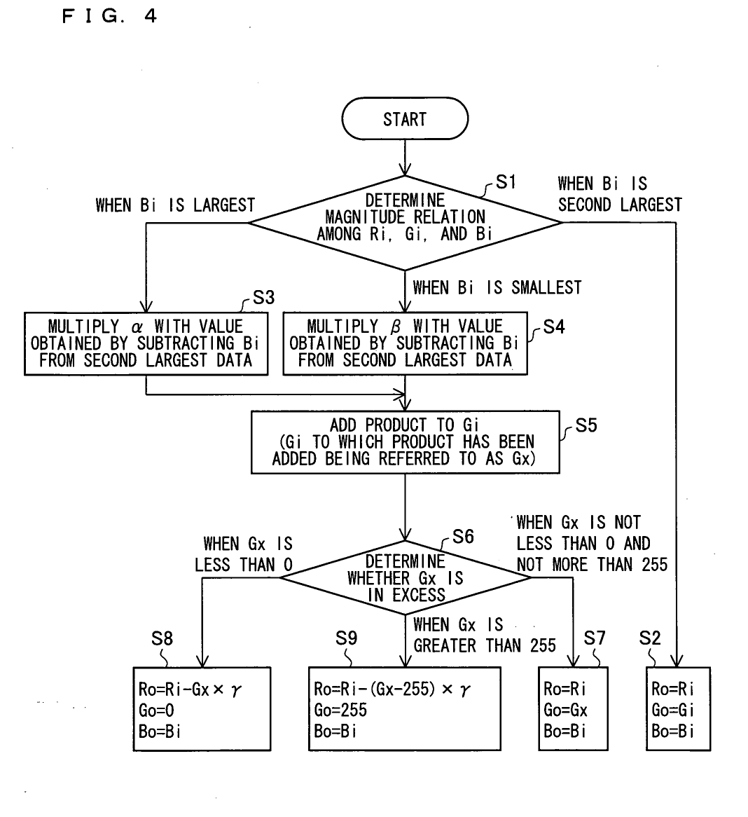

Specific examples of a process of chromaticity conversion by the chromaticity converting device 30 will be described with reference to the block diagram of FIG. 2, the chromaticity diagram of FIG. 3, and the flow chart of FIG. 4.

First, the hue determining unit 31 determines a magnitude relation among respective gradations of data Ri, Gi, and Bi that have been inputted (Step S1). When the gradation of the data Bi is larger than the other gradations, the chromaticity of the data Ri, Gi, and Bi is located in a region A1 of FIG. 3. When the gradation of the data Bi is smaller than the other gradations, the chromaticity is located in a region A2 of FIG. 3.

Regions other than the regions A1 and A2 are away from blue or yellow, and therefore have low demand for chromaticity conversion. Therefore, in cases where the chromaticity of the data Ri, Gi, and Bi is located in any one of those regions other than the regions A1 and A2 as a result of the hue determination, the data Ri, Gi, and Bi are directly outputted as data Ro, Go, and Bo without correction (Step S2).

In cases where the chromaticity of the data Ri, Gi, and Bi is located in the region A1 or A2, the following process is carried out.

In cases where the chromaticity of the data Ri, Gi, and Bi is located in the region A1 or A2 as a result of the hue determination, the B component calculating unit 32 calculates the difference between the gradation of the data Bi and the second largest gradation of all the gradations of the data Ri, Gi, and Bi, and the difference serves as a basic value of the amount of correction of the data Gi. Specifically, in cases where Ri=65, Gi=20, and Bi=255, the B component calculating unit 32 outputs Ri−Bi=−160. Alternatively, in cases where Ri=220, Gi=225, and Bi=20, the B component calculating unit 32 outputs Ri−Bi=200.

Then, the G correction amount calculating unit 33 multiplies the output of the B component calculating unit 32 with a predetermined constant α or β, thereby yielding the amount of correction of the data Gi. The constant α is a constant that is used in cases where the output of the B component calculating unit 32 is negative (i.e., in cases where the chromaticity of the data Ri, Gi, and Bi is located in the region A1). The constant β is a constant that is used in cases where the output of the B component calculating unit 32 is positive (i.e., in cases where the chromaticity of the data Ri, Gi, and Bi is located in the region A2). Specifically, in cases where Ri=65, Gi=20, Bi=225, and α=0.25, the G correction amount calculating unit 33 outputs −160×α=−40 (Step S3). Alternatively, in cases where Ri=220, Gi=225, Bi=20, and β=0.25, the G correction amount calculating unit 33 outputs 200×β=50 (Step S4).

In this way, Bi=Ri and Bi=Gi on the lines C-W and M-W of FIG. 3, respectively; therefore, the outputs of the B component calculating unit 32 and the G correction amount calculating unit 33 are both 0. As a result, the amount of correction of the data Gi is also 0. That is, no chromaticity conversion is made in this case. Meanwhile, as the chromaticity expressed by the data Ri, Gi, and Bi becomes closer to B, the absolute value |Ri−Bi| or |Gi−Bi| of the output of the B component calculating unit 32 becomes larger, so that the amount of chromaticity conversion also becomes larger.

Similarly, Bi=Ri and Bi=Gi on the lines G-W and R-W of FIG. 3, respectively; therefore, the outputs of the B component calculating unit 32 and the G correction amount calculating unit 33 are both 0. As a result, no chromaticity conversion is performed. As the chromaticity expressed by the data Ri, Gi, and Bi becomes closer to Y, the absolute value |Ri−Bi| or |Gi−Bi| of the output of the B component calculating unit 32 becomes larger, so that the amount of chromaticity conversion also becomes larger.

The output of the B component calculating unit 32 is multiplied with the constant α or β for the following reason. Color filters vary in the amounts of green that is transmitted by their respective blue color filters. Therefore, color filters vary in appropriateness of the amounts of chromaticity conversion. In view of this, it is desirable that the degree of correction (to which chromaticity conversion is made, i.e., to which the data Gi is corrected) be set depending on color filters. For this purpose, the degree of correction for blue is set by the constant α, and the degree of correction for yellow is set by the constant β.

The constants α and β vary in their respective appropriate values depending on color filters. Therefore, it is desirable that the chromaticity converting device 30 has a memory provided inside or outside thereof, that the memory stores several gradual patterns of values of each of the constants α and β within the range of approximately 0 to 0.5 in accordance with a color filter used, and that the constants α and β be changed by selecting their respective values from the patterns.

After the amount of correction of the data Gi has been determined by the G correction amount calculating unit 33 as described above, the G data computing unit 34 adds the input data Gi and the output of the G correction amount calculating unit 33 (Step S5). Specifically, in cases where Ri=65, Gi=20, Bi=225, and α=0.25, the G data computing unit 34 outputs 20−40=−20. Alternatively, in cases where Ri=220, Gi=225, Bi=20, and β=0.25, the G data computing unit 34 outputs 225+50=275.

Then, the excess determining unit 35 determines whether or not the output of the G data computing unit 34 (such an output being referred to as “Gx”) is less than 0, or whether or not Gx is greater than 255 (Step S6). If Gx is directly outputted as Go in cases where Gx is less than 0 or greater than 255, the gradation is not actually expressed and blurs.

In view of this, in cases where Gx is less than 0 or greater than 255, the gradation of R is increased or decreased by the number of gradations that are not expressed by G (by the number of gradations that exceed the expressible gradations). Chromaticity conversion and gradation expression are realized by commuting the lost gradations of G to R.

For example, when Gx is not less than 0 and not more than 255, the excess determining unit 35 outputs 0 to the R data computing unit 36 and directly outputs Gx as Go (Step S7).

On the other hand, when Gx is less than 0, the excess determining unit 35 outputs 0 as Go and outputs, to the R data computing unit 36, a value obtained by multiplying Gx with a predetermined constant γ. Alternatively, when Gx is greater than 255, the excess determining unit 35 outputs 255 as Go and outputs, to the R data computing unit 36, a value obtained by multiplying the constant γ with a value obtained by subtracting 255 from Gx.

The constant γ varies in its appropriate value depending on color filters. Therefore, as with the constants α and β, it is desirable that the chromaticity converting device 30 have a memory provided inside or outside thereof, that the memory store several gradual patterns of the constant γ within the range of approximately 0.25 to 1 in accordance with a color filter in use, and that the constant γ be changed by selecting its value from the patterns. In cases where the constants α and β can be changed, an adjustment can be made by the constants α and β. Therefore, the constant γ may be assigned a fixed value within the range of approximately 0.25 to 1.

Specifically, in cases where Ri=65, Gi=20, Bi=225 α=0.25, and γ=0.5, the G data computing unit 34 outputs −20 (Gx=−20). Therefore, Go is 0 and the R data computing unit 36 receives −20×γ=−10. Alternatively, in cases where Ri=220, Gi=225, Bi=20, β=0.25, and γ=0.5, the G data computing unit 34 outputs 275 (Gx=275). Therefore, Go is 255 and the R data computing unit 36 receives (275−255)×γ=10.

Then, the R data computing unit 36 computes the difference between the input data Ri and the output of the excess determining unit 35, and outputs the difference as Ro (Steps S8 and S9).

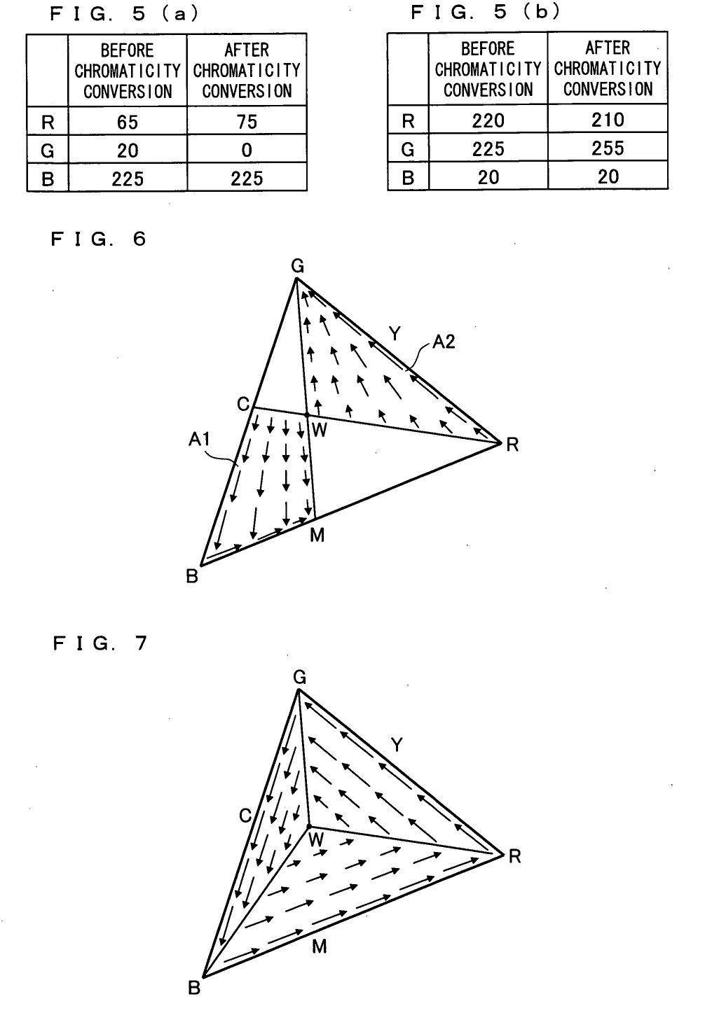

Specifically, in cases where Ri=65, Gi=20, Bi=225, α=0.25, and γ=0.5, the excess determining unit 35 outputs −10 to the R data computing unit 36. Therefore, Ro is 65+10=75, so that Ro=75, Go=0, and Bo=225. These are tabulated as shown in FIG. 5(a).

Alternatively, in cases where Ri=220, Gi=225, Bi=20, β=0.25, and γ=0.5, the excess determining unit 35 outputs 10 to the R data computing unit 36. Therefore, Ro is 220−10=210, so that Ro=210, Go=255, and Bo=20. These are tabulated as shown in FIG. 5(b).

A change in chromaticity on x-y chromaticity coordinates due to the aforementioned chromaticity conversion will be explained with reference to the chromaticity diagram of FIG. 6. In FIG. 6, the direction of an arrow means the direction of a shift in x-y chromaticity coordinates (chromaticity conversion direction), and the length of an arrow means the shift amount of the x-y chromaticity coordinates (chromaticity conversion amount). FIG. 6 shows that the chromaticity conversion amount is small in the vicinity of the lines C-W and M-W of the region A1 and in the vicinity of the lines G-W and R-W of the region A2 and that the chromaticity conversion amount becomes larger at a shorter distance away from B and Y.

Further, FIG. 6 also shows that, unlike the uniform chromaticity conversion of FIG. 7, the aforementioned chromaticity conversion is suitable for correcting the problem of transmission of green light by the blue color filter.

That is, a shift in characteristics of the color filter can be appropriately corrected by reducing the gradation of green in a region (region A1) containing a large amount of blue components, and by adding the gradation of red in cases where the gradation of green is less than 0. Alternatively, a shift in characteristics of the color filter is appropriately corrected by increasing the gradation of green in a region (region A2) containing a small amount of blue components, and by reducing the gradation of red in cases where the gradation of green is greater than 255.

As compared with the chromaticity conversion of FIG. 7, the chromaticity conversion of the present embodiment brings about such an advantageous effect that a decrease in saturation can be remedied in the triangle region BMW. The reason is as follows.

Basically, saturation has such properties as to improve as the difference in maximum and minimum luminances among RGB becomes larger. In the triangle region BMW, the maximum luminance is indicated by blue light and the minimum luminance is indicated by green light.

When a leakage of green light from the blue color filter is corrected by the chromaticity conversion of FIG. 7, the leakage is corrected by increasing the gradation of red in the triangle region BMW. This means to increase red components in order to eliminate the state in which green light is leaking (i.e., the state in which a larger amount of green components is contained than supposed to be contained). Then, the state in which a larger amount of green light is contained than supposed is maintained before and after the correction. This makes it impossible to correct the state in which the difference in luminance between the blue light indicative of the maximum luminance and the green light indicative of the minimum luminance is smaller than supposed. Therefore, the state in which the saturation is lower than supposed is not remedied.

On the other hand, according to the chromaticity conversion of the present embodiment, a shift in hue is corrected by reducing the amount of green light contained more than supposed and causing the amount to be closer to a proper amount. Therefore, at the same time, the difference in luminance between the blue light indicative of the maximum luminance and the green light indicative of the minimum luminance can be made closer to a proper size. This makes it possible to remedy a decrease in saturation.

According to the chromaticity conversion of the present embodiment, also in the triangle region BMW of FIG. 6, the gradation of leaking green is reduced so that the leakage of green light from the blue color filter is corrected. This makes it possible to correct a shift in characteristics of the color filter while suppressing a decrease in saturation.

As described above, according to the chromaticity conversion of the present embodiment as shown in FIG. 6, the gradation of G data is converted so as to decrease in a predetermined region A1 around B within a range of chromaticities expressible by an RGB signal, and the gradation of G data is converted so as to increase in a predetermined region A2 around Y, which is a complementary color of G, within the range of chromaticities.

The “predetermined region around B” in the present embodiment means, but is not limited to, the quadrangle region BMWC of FIG. 6, and may be a region that is closer to B than a predetermined boundary one end of which is located on a line connecting B with G (excluding the chromaticity coordinates of B) and the other end of which is located on a line connecting B with R (excluding the chromaticity coordinates of B). Similarly, the “predetermined region around Y” in the present embodiment means, but is not limited to, the triangle region RGW of the FIG. 6, and may be a region that is closer to Y than a predetermined boundary one end of which is located on a line connecting Y with G (excluding the chromaticity coordinates of Y) and the other end of which is located on a line connecting Y with R (excluding the chromaticity coordinates of Y). Note that the “predetermined region around B” and the “predetermined region around Y” are set so as not to overlap each other.

With this, a shift in hue close to B can be corrected by converting the gradation of the G data so that the gradation of the G data decreases in the predetermined region around B, and a shift in hue close to Y can be corrected by converting the gradation of the G data so that the gradation of the G data increases in the predetermined region around Y.

Further, a shift in chromaticity due to a shift in hue in the liquid crystal display apparatus 11 becomes larger as the chromaticity expressed by the data Ri, Gi, and Bi becomes closer to B and Y. In view of this, according to the chromaticity conversion of the present embodiment, as the chromaticity expressed by the data Ri, Gi, and Bi becomes closer to B and Y, the gradation of the G data is converted so that the amount of decrease and increase (amount of correction) of the gradation of the G data becomes larger. This makes it possible to make an appropriate correction in accordance with the aforementioned degree of shift in the liquid crystal display apparatus 11.

It is desirable that the amount of correction be thus set in accordance with the chromaticity expressed by the data Ri, Gi, and Bi. However, for example, it is possible to obtain a certain degree of effect even if the amount of correction in the predetermined region around B and the predetermined region around Y are held constant regardless of the chromaticity expressed by the data Ri, Gi, and Bi.

### Embodiment 2

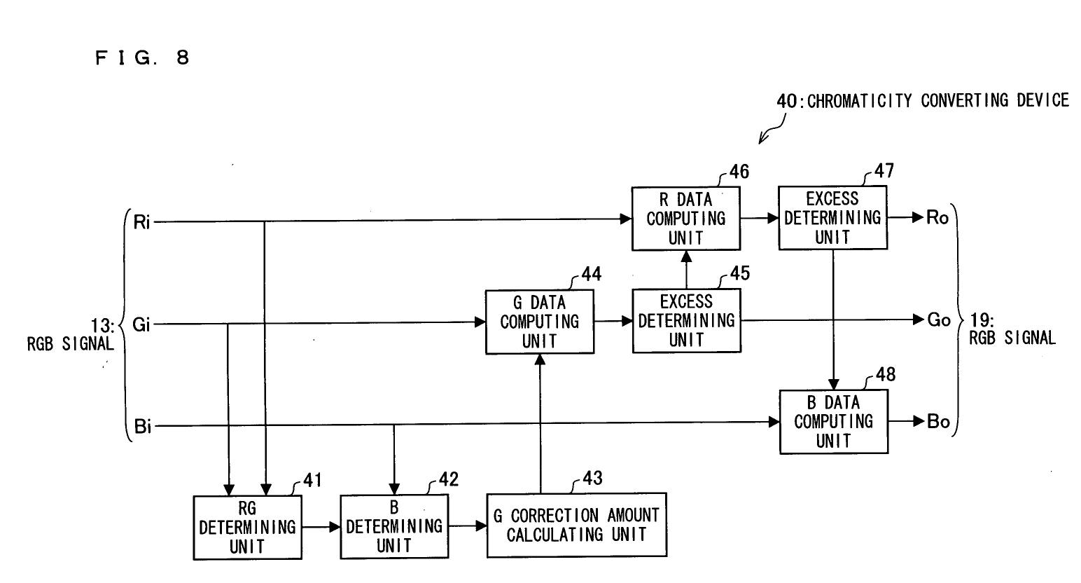

Another embodiment of the present invention will be described below with reference to FIGS. 8 through 13.

The present embodiment also presupposes the entire arrangement of the apparatus described with reference to FIG. 1 in Embodiment 1, and differs from Embodiment 1 only in terms of its chromaticity converting device. Therefore, the following describes an arrangement of the chromaticity converting device.

FIG. 8 is a block diagram showing an arrangement of the chromaticity converting device 40 of the present embodiment. As shown in FIG. 8, the chromaticity converting device 40 includes an RG determining unit 41, a B determining unit 42, a G correction amount calculating unit 43, a G data computing unit 44, an excess determining unit 45, an R data computing unit 46, an excess determining unit 47, and a B data computing unit 48.

In the present embodiment, the chromaticity converting device 40 is divided into eight functional blocks shown in FIG. 8. However, in designing an actual circuit, these blocks may be appropriately combined or separated. For example, the RG determining unit 41 and the B determining unit 42 may be realized by a single circuit.

The following explains the principle of chromaticity conversion in the present embodiment. According to the chromaticity conversion of Embodiment 1, the gradation of the data Gi is not corrected in those regions other than the regions A1 and A2. However, in reality, there are some shifts in hue in the triangle regions GCW and WMR of FIG. 3 under the influence of green light leaking from the blue color filter.

In view of this, a hue correction better suited to the characteristics of the color filter can be realized by making no correction only in cases of an achromatic color (Ri=Gi=Bi, W of FIG. 3), Gi>Ri=Bi (line G-W of FIG. 3), and Ri>Gi=Bi (line G-W of FIG. 3), by reducing the gradation of green more greatly in that part of the quadrangle region GBRW of FIG. 3 which is close to blue, and by increasing the gradation of green more greatly in that part of the triangle region GWR of FIG. 3 which is close to yellow.

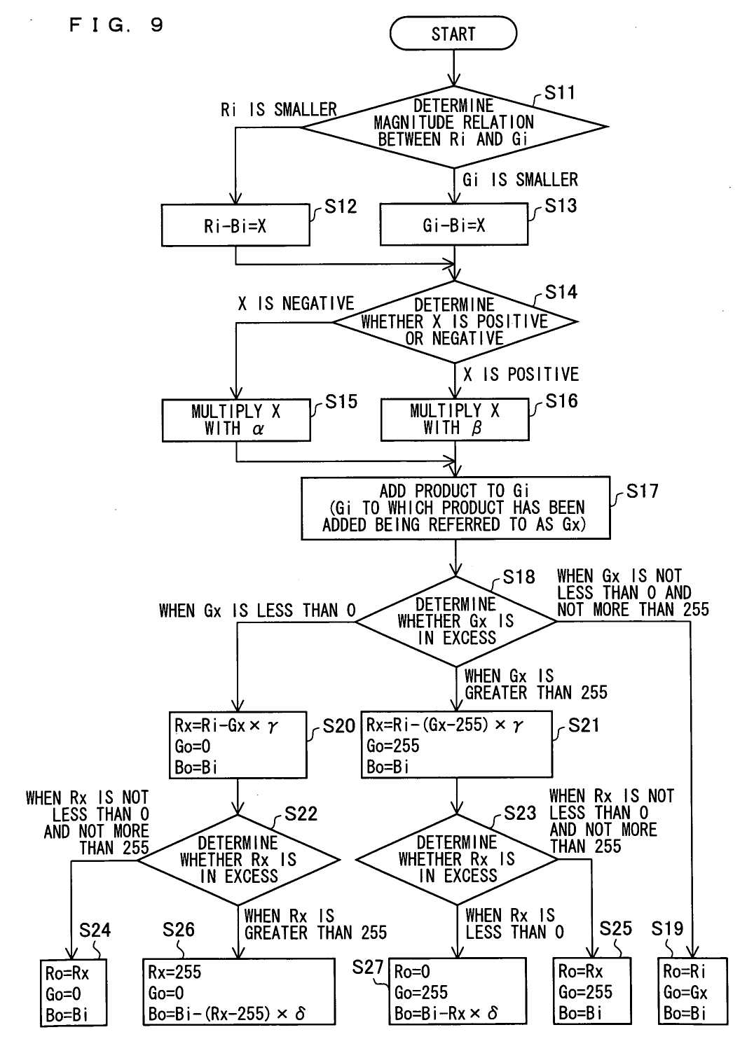

Specific examples of a process of chromaticity conversion by the chromaticity converting device 40 will be described with reference to the block diagram of FIG. 8 and the flow chart of FIG. 9.

First, the RG determining unit 41 determines a magnitude relation among respective gradations of data Ri, Gi, and Bi that have been inputted (Step S11), and outputs the smaller one of the gradations of the data Ri and Gi to the B determining unit 42. Specifically, in cases where Ri=255, Gi=0, and Bi=255, the RG determining unit 41 outputs Gi=0 to the B determining unit 42. Alternatively, in cases where Ri=255, Gi=255, and Bi=0, the RG determining unit 41 outputs 255.

Then, the B determining unit 42 outputs, to the G correction amount calculating unit 43, a value obtained by subtracting the gradation of the data Bi from the output of the RG determining unit 41 (Steps S12 and S13). Specifically, in cases where Ri=255, Gi=0, and Bi=255, the B determining unit 42 outputs 0-255=−255. Alternatively, in cases where Ri=255, Gi=255, and Bi=0, the B determining unit 42 outputs 255-0=255.

Then, the G correction amount calculating unit 43 determines whether the output of the B determining unit 42 (such an output being referred to as “X”) is positive or negative (Step S14). In cases where X is negative, X is multiplied with a predetermined constant α (Step S15). In cases where X is positive, X is multiplied with a predetermined constant β (Step S16). The value thus obtained serves as the amount of correction of the data Gi. Specifically, in cases where Ri=255, Gi=0, Bi=255, and α=0.25, the G correction amount calculating unit 43 outputs −255×α≈−64. Alternatively, in cases where Ri=255, Gi=255, Bi=0, and β=0.125, the G correction amount calculating unit 43 outputs 255×β≈32.

In this way, the output of the G correction amount calculating unit 43 is 0 on the lines G-W and R-W of FIG. 6; therefore, the amount of correction of the data Gi is also 0. That is, no chromaticity conversion is made in this case. Meanwhile, as the chromaticity expressed by the data Ri, Gi, and Bi becomes closer to C, B, M, and Y, the absolute value of the amount of correction of the data Gi becomes larger, so that the amount of chromaticity conversion also becomes larger.

The output of the B determining unit 42 is multiplied with the constant α or β for the same reason as in Embodiment 1. That is, the degree of correction (to which chromaticity conversion is made, i.e., to which the data Gi is corrected) is set depending on color filters. For this purpose, the degree of correction for blue is set by the constant α, and the degree of correction for yellow is set by the constant β.

The constants α and β vary their respective appropriate values depending on color filters. Therefore, as with Embodiment 1, it is desirable that the chromaticity converting device 40 has a memory provided inside or outside thereof, that the memory stores several gradual patterns of values of each of the constants α and β within the range of approximately 0 to 0.5 in accordance with a color filter used, and that the constants α and β be changed by selecting their respective values from the patterns.

After the amount of correction of the data Gi has been determined by the G correction amount calculating unit 43 as described above, the G data computing unit 44 adds the input data Gi and the output of the G correction amount calculating unit 43 (Step S17). Specifically, in cases where Ri=255, Gi=0, Bi=255, and α=0.25, the G data computing unit 44 outputs 0-64=−64. Alternatively, in cases where Ri=255, Gi=255, Bi=0, and β=0.125, the G data computing unit 44 outputs 225+32=287.

Then, the excess determining unit 45 determines whether or not the output of the G data computing unit 44 (such an output being referred to as “Gx”) is less than 0, or whether or not Gx is greater than 255 (Step S18). If Gx is directly outputted as Go in cases where Gx is less than 0 or greater than 255, the gradation is not actually expressed and blurs. In view of this, in cases where Gx is less than 0 or greater than 255, the gradation of R is increased or decreased by the number of gradations that are not expressed by G (by the number of gradations that exceed the expressible gradations). Chromaticity conversion and gradation expression are realized by commuting the lost gradations of G to R.

For example, when Gx is not less than 0 and not more than 255, the excess determining unit 45 outputs 0 to the R data computing unit 46 and directly outputs Gx as Go (Step S19).

On the other hand, when Gx is less than 0, the excess determining unit 45 outputs 0 as Go and outputs, to the R data computing unit 46, a value obtained by multiplying Gx with a predetermined constant γ.

Alternatively, when Gx is greater than 255, the excess determining unit 45 outputs 255 as Go and outputs, to the R data computing unit 46, a value obtained by multiplying the constant γ with a value obtained by subtracting 255 from Gx.

The constant γ varies in its appropriate value depending on color filters. Therefore, as with the constants α and β, it is desirable that the chromaticity converting device 30 have a memory provided inside or outside thereof, that the memory store several gradual patterns of the constant γ within the range of approximately 0.25 to 1 in accordance with a color filter in use, and that the constant γ be changed by selecting its value from the patterns. In cases where the constants α and β can be changed, an adjustment can be made by the constants α and β. Therefore, the constant γ may be assigned a fixed value within the range of approximately 0.25 to 1.

Specifically, in cases where Ri=255, Gi=0, Bi=255, α=0.25, and γ=0.5, the G data computing unit 44 outputs −64 (Gx=−64). Therefore, Go is 0 and the R data computing unit 46 receives −64×γ=−32. Alternatively, in cases where Ri=255, Gi=255, Bi=0, β=0.125, and γ=0.5, the G data computing unit 44 outputs 287 (Gx=287). Therefore, Go is 255 and the R data computing unit 46 receives (287−255)×γ=16.

Then, the R data computing unit 46 computes the difference between the input data Ri and the output of the excess determining unit 45, and outputs the difference to the excess determining unit 47 (such an output being referred to as “Rx”) (Steps S20 and S21).

Specifically, in cases where Ri=255, Gi=0, Bi=255, α=0.25, and γ=0.5, the excess determining unit 45 outputs −32 to the R data computing unit 46. Therefore, the R data computing unit 46 outputs 255+32=287 (Rx=287). Alternatively, in cases where Ri=255, Gi=255, Bi=0, β=0.125, and γ=0.5, the excess determining unit 45 outputs 16 to the R data computing unit 46. Therefore, the R data computing unit 46 outputs 255−16=239 (Rx=239).

Then, the excess determining unit 47 determines whether or not Rx is less than 0, or whether or not Rx is greater than 255 (Steps S22 and S23). If Rx is directly outputted as Ro in cases where Rx is less than 0 or greater than 225, the gradation is not actually expressed and blurs.

In view of this, in cases where Rx is less than 0 or greater than 255, the gradation of B is increased or decreased by the number of gradations that are not expressed by R (by the number of gradations that exceed the expressible gradations). Chromaticity conversion and gradation expression are realized by commuting the lost gradations of R to G.

For example, when Rx is not less than 0 and not more than 255, the excess determining unit 47 outputs 0 to the B data computing unit 48 and directly outputs Rx as Ro (Steps S24 and S25).

On the other hand, when Rx is less than 0, the excess determining unit 47 outputs 0 as Ro and outputs, to the B data computing unit 48, a value obtained by multiplying Rx with a predetermined constant 5. Alternatively, when Rx is greater than 255, the excess determining unit 47 outputs 255 as Ro and outputs, to the B data computing unit 48, a value obtained by multiplying the constant δ with a value obtained by subtracting 255 from Rx.

The constant δ varies in its appropriate value depending on color filters. Therefore, it is desirable that the chromaticity converting device 40 have a memory provided inside or outside thereof, that the memory store several gradual patterns of the constant δ within the range of approximately 0.25 to 1 in accordance with a color filter used, and that the constant δ be changed by selecting its value from the patterns. In cases where the constants α and β can be changed, an adjustment can be made by the constants α and β. Therefore, the constant δ may be assigned a fixed value within the range of approximately 0.25 to 1.

Specifically, in cases where Ri=255, Gi=0, Bi=255, α=0.25, γ=0.5, and δ=0.5, the R data computing unit 46 outputs 287 (Rx=287). Therefore, Ro is 255 and the B data computing unit 48 receives (287-255)×δ=16. Alternatively, in cases where Ri=255, Gi=255, Bi=0, β=0.125, and γ=0.5, the R data computing unit 46 outputs 239 (Rx=239). Therefore, Ro is 239 and the B data computing unit 48 receives 0.

Then, the B data computing unit 48 computes the difference between the input data Bi and the output of the excess determining unit 47, and outputs the difference as Bo (Steps S26 and S27).

Specifically, in cases where Ri=255, Gi=0, Bi=255, α=0.25, γ=0.5 and δ=0.5, the excess determining unit 47 outputs 16 to the B data computing unit 48. Therefore, Bo is 255−16=239, so that Ro=255, Go=0, and Bo=239. These are tabulated as shown in FIG. 10(a).

Alternatively, in cases where Ri=255, Gi=255, Bi=0, β=0.125, and γ=0.5, the excess determining unit 47 outputs 0 to the B data computing unit 48. Therefore, Bo is 0−0=0, so that Ro=239, Go=255, and Bo=0. These are tabulated as shown in FIG. 10(b).

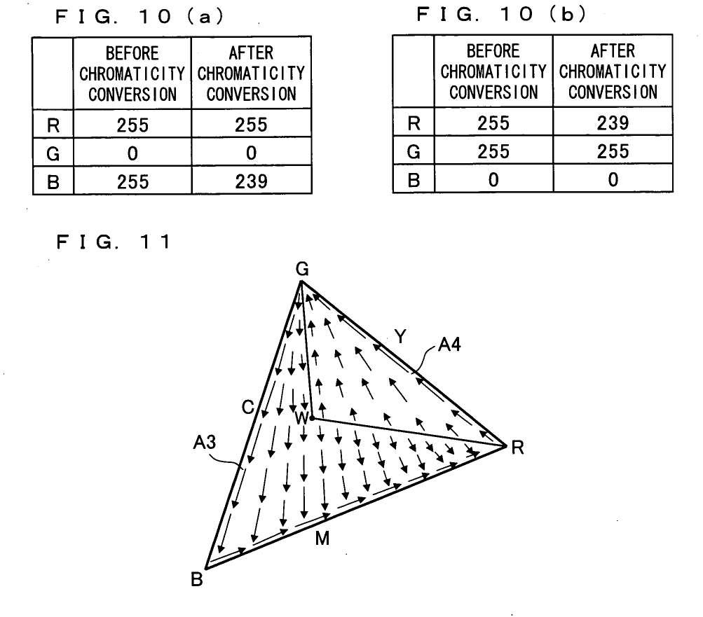

A change in chromaticity on x-y chromaticity coordinates due to the aforementioned chromaticity conversion will be explained with reference to the chromaticity diagram of FIG. 11. In FIG. 11, as in FIG. 6, the direction of an arrow means the direction of a shift in x-y chromaticity coordinates (chromaticity conversion direction), and the length of an arrow means the shift amount of the x-y chromaticity coordinates (chromaticity conversion amount). FIG. 11 shows that the chromaticity conversion amount is small in the vicinity of the lines G-W and R-W that the chromaticity conversion amount becomes larger at a shorter distance away from C, B, M, and Y.

Further, FIG. 11 also shows that, unlike the uniform chromaticity conversion of FIG. 7, the aforementioned chromaticity conversion is suitable for correcting the problem of transmission of green light by the blue color filter.

That is, a shift in characteristics of the color filter can be appropriately corrected by reducing the gradation of green in a region containing a large amount of blue components, and by increasing the gradation of red and reducing the gradation of blue in some cases. Alternatively, a shift in characteristics of the color filter can be appropriately corrected by increasing the gradation of green in a region containing a small amount of blue components, and by reducing the gradation of red and increasing the gradation of blue in some cases.

As described above, according to the chromaticity conversion of the present embodiment as shown in FIG. 11, the gradation of G data is converted so as to decrease in a predetermined region A3 around B within a range of chromaticities expressible by an RGB signal, and the gradation of G data is converted so as to increase in a predetermined region A4 around Y, which is a complementary color of G, within the range of chromaticities.

The “predetermined region around B” in the present embodiment means, but is not limited to, the quadrangle region BRWG of FIG. 11, and may be a region that is closer to B than a predetermined boundary one end of which is located on a line connecting B with G (excluding the chromaticity coordinates of B) and the other end of which is located on a line connecting B with R (excluding the chromaticity coordinates of B). Similarly, the predetermined region around Y” in the present embodiment means, but is not limited to, the triangle region RGW of the FIG. 11, and may be a region that is closer to Y than a predetermined boundary one end of which is located on a line connecting Y with G (excluding the chromaticity coordinates of Y) and the other end of which is located on a line connecting Y with R (excluding the chromaticity coordinates of Y). Note that the “predetermined region around B” and the “predetermined region around Y” are set so as not to overlap each other.

With this, a shift in hue close to B can be corrected by converting the gradation of the G data so that the gradation of the G data decreases in the predetermined region around B, and a shift in hue close to Y can be corrected by converting the gradation of the G data so that the gradation of the G data increases in the predetermined region around Y.

Further, a shift in chromaticity due to a shift in hue in the liquid crystal display apparatus 11 becomes larger as the chromaticity expressed by the data Ri, Gi, and Bi becomes closer to B and Y. In view of this, according to the chromaticity conversion of the present embodiment, as the chromaticity expressed by the data Ri, Gi, and Bi becomes closer to B and Y, the gradation of the G data is converted so that the amount of decrease and increase (amount of correction) of the gradation of the G data becomes larger. This makes it possible to make an appropriate correction in accordance with the aforementioned degree of shift in the liquid crystal display apparatus 11.

It is desirable that the amount of correction be thus set in accordance with the chromaticity expressed by the data Ri, Gi, and Bi. However, for example, it is possible to obtain a certain degree of effect even if the amount of correction in the predetermined region around B and the predetermined region around Y are held constant regardless of the chromaticity expressed by the data Ri, Gi, and Bi.

The following further explains how to set the constants α, β, γ, and δ explained in Embodiments 1 and 2.

A human eye is characterized so as to often feel more uncomfortable with a shift in hue than in saturation. For example, in cases where a color display apparatus displays a blue sky that is richer or poorer in blue than originally due to a shift in saturation of blue, the human eye rarely feels uncomfortable with this. However, in cases where the blue sky is more greenish than originally due to a shift in hue of blue, the human eye often feels uncomfortable with the strangeness of blue.

In view of this, in the chromaticity conversion of Embodiment 1 and 2, it is desirable that the constants α, β, γ, and δ be set so that hue is better adjusted than saturation.

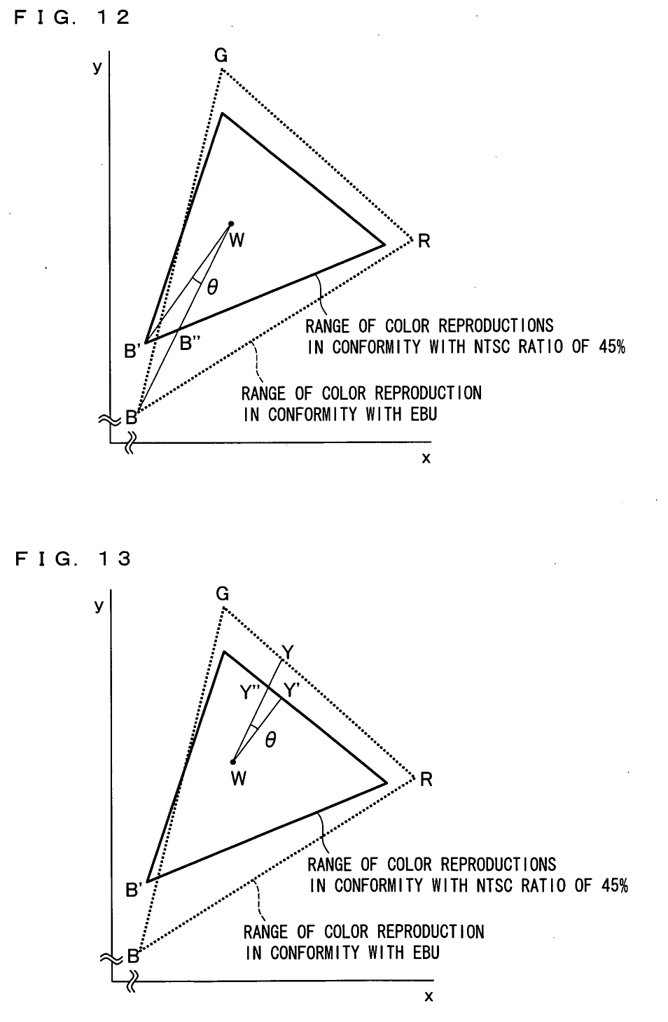

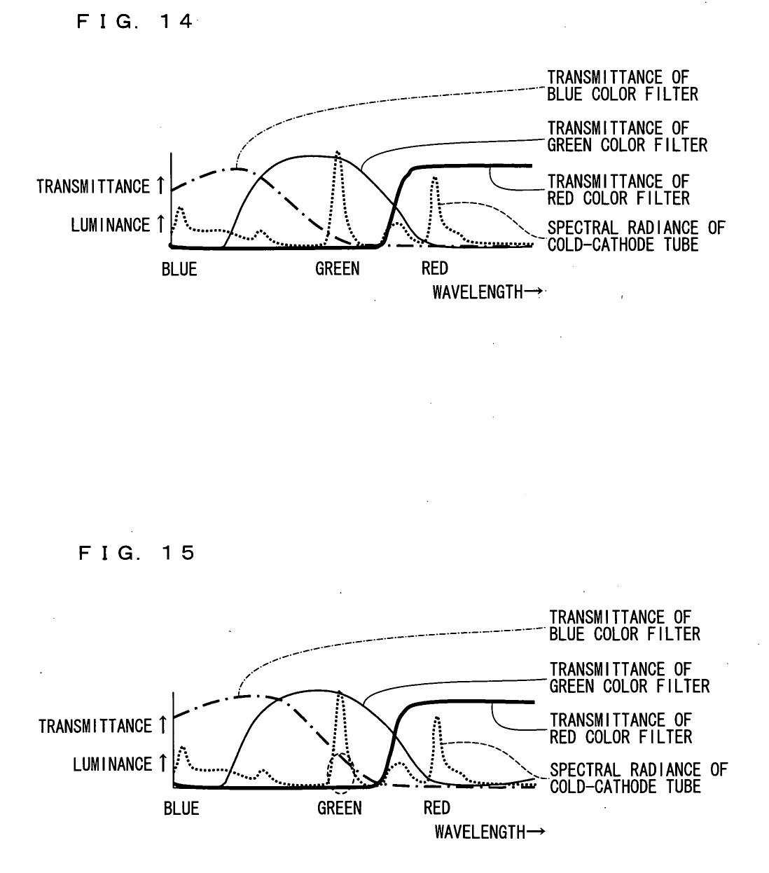

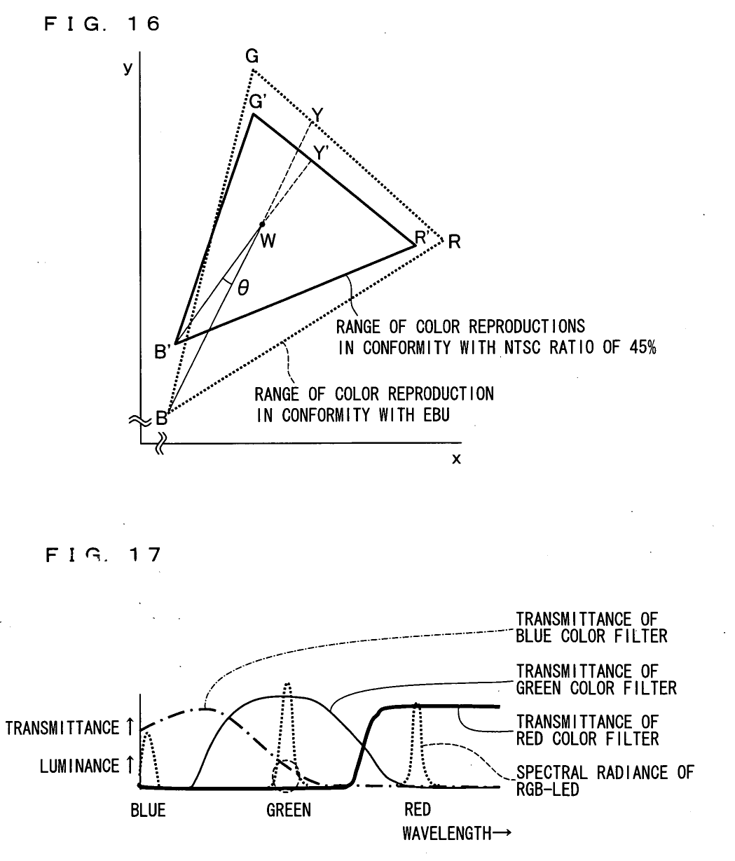

This will be explained below with reference to the chromaticity diagrams of FIGS. 12 and 13.

The blue supposed to be expressed on the chromaticity coordinates B of FIG. 12 is expressed on the chromaticity coordinates B′ due to the color filter problems. B and B′ form an angle θ with each other as seen from W. This causes a shift in hue corresponding to the angle θ.

In order to adjust the hue of B′ to the original hue of B, it is desirable that, when B″ is a point of intersection between a line connecting W with B and a line connecting B′ with R corresponding to an NTSC ratio of 45%, the constants α, γ, and δ be set so that chromaticity conversion from B′ to substantially B″ is made.

With this, the B supposed to be expressed and the B″ obtained after the chromaticity conversion are substantially identical in hue to each other. This makes it possible to express blue, short in saturation but substantially identical in hue, which brings little discomfort.

The same applies to yellow. The yellow supposed to be expressed on the chromaticity coordinates Y of FIG. 13 is expressed on the chromaticity coordinates Y′ due to the color filter problems. Y and Y′ form an angle θ with each other as seen from W. This causes a shift in hue corresponding to the angle θ.

In order to adjust the hue of Y′ to the original hue of Y, it is desirable that, when Y″ is a point of intersection between a line connecting W with Y and a line connecting R corresponding to an NTSC ratio of 45% with G, the constants β, γ, and δ be set so that chromaticity conversion from Y′ to substantially Y″ is made.

With this, the Y supposed to be expressed and the Y″ obtained after the chromaticity conversion are substantially identical in hue to each other. This makes it possible to express yellow, short in saturation but substantially identical in hue, which brings little discomfort.

The chromaticity conversion makes it possible to effectively use a reproducible triangle range without narrowing a triangle range of chromaticity reproductions by a color filter.

The optimum values of the constants α, β, γ, and δ vary depending on color filters, and are also affected by a human sense. Therefore, in setting the constants α, β, γ, and δ, it is only necessary to conduct such an experiment of calculating optimum values for each color filter by adjusting each of the values while observing a display state. The result of the experiment shows that, in any one of Embodiments 1 and 2, the optimum values of the constants α, β, γ, and δ were 0.5, 0.125, 0.5, and 0.5, respectively, for a color filter having an NTSC ratio of 45%.

Embodiments 1 and 2 have been described on the premise of a shift in hue attributed to the characteristics of a color filter. However, as described in BACKGROUND ART, a similar shift in hue is caused by the characteristics of an LED. The chromaticity conversion of the present embodiment is effective also against such a shift in hue.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention can be used for chromaticity conversion of a three-primary-color signal such as an RGB signal, and can be suitably used especially for chromaticity conversion in a liquid crystal display apparatus.

1. A chromaticity converting device for performing chromaticity conversion with respect to a three-primary color signal including first to third color data indicating gradations of first to third colors, respectively,
the gradation of the second color data being converted so as to decrease in a predetermined region around the first color within a range of chromaticities expressible by the three-primary-color signal,
the gradation of the second color data being converted so as to increase in a predetermined region around a complementary color of the first color within the range of chromaticities.

2. The chromaticity converting device as set forth in claim 1, wherein the gradations of the first to third color data are not converted in a region other than the predetermined region around the first color and the predetermined region around the complementary color of the first color within the range of chromaticities.

3. The chromaticity converting device as set forth in claim 1, wherein the gradation of the second color data is converted so that:
as a chromaticity expressed by the three-primary-color signal becomes closer to the first color, an amount by which the gradation of the second color data decreases in the predetermined region around the first color becomes larger; and
as the chromaticity expressed by the three-primary-color signal becomes closer to the complementary color of the first color, an amount by which the gradation of the second color data increases in the predetermined region around the complementary color of the first color becomes larger.

4. The chromaticity converting device as set forth in claim 1, wherein:
the predetermined region around the first color is a region, surrounded by the first color, a complementary color of the second color, a complementary color of the third color, and an achromatic color, which falls within the range of chromaticities; and
the predetermined region around the complementary color of the first color is a region surrounded by the second color, the third color, and the achromatic color.

5. The chromaticity converting device as set forth in claim 4, wherein:
when the gradation of the second color data is below a lower limit value, the gradation of the third color data is converted so as to increase; and
when the gradation of the second color data is above an upper limit value, the gradation of the third color data is converted so as to decrease.

6. The chromaticity converting device as set forth in claim 1, wherein:
the predetermined region around the first color is a region, surrounded by the first color, the second color, the third color, and an achromatic color, which falls within the range of chromaticities; and
the predetermined region around the complementary color of the first color is a region surrounded by the second color, the third color, and the achromatic color.

7. The chromaticity converting device as set forth in claim 6, wherein:
when the gradation of the second color data is below a lower limit value, the gradation of the third color data is converted so as to increase; and
when the gradation of the second color data is above an upper limit value, the gradation of the third color data is converted so as to decrease.

8. The chromaticity converting device as set forth in claim 7, wherein:
when the gradation of the third color data is below a lower limit value, the gradation of the first color data is converted so as to increase; and
when the gradation of the third color data is above an upper limit value, the gradation of the first color data is converted so as to decrease.

9. The chromaticity converting device as set forth in claim 1, wherein the first to third colors are blue, green, and red, respectively.

10. A timing controller for controlling timing of a signal in an image display apparatus, comprising a chromaticity converting device as set forth in claim 1.

11. A liquid crystal display apparatus comprising:
a chromaticity converting device as set forth in claim 1; and
a liquid crystal panel having color filters respectively corresponding to first to third colors.

12. A chromaticity converting method for performing chromaticity conversion with respect to a three-primary color signal including first to third color data indicating gradations of first to third colors, respectively,
the gradation of the second color data being converted so as to decrease in a predetermined region around the first color within a range of chromaticities expressible by the three-primary-color signal,
the gradation of the second color data being converted so as to increase in a predetermined region around a complementary color of the first color within the range of chromaticities.
